(19) United States
(12) Patent Application Publication
(10) Pub. No.: US 2002/0066417 A1
(43) Pub. Date: Jun. 6, 2002

(54) Tethering system for an animal and method of use

(76) Inventors: Tod W. Frazer, North Windham, CT (US); Daniel Ebberup, Jewett City, CT (US)

Correspondence Address: Timothy T. Tyson, Freilich, Hornbaker & Rosen, 10960 Wilshire Blvd., Suite 1220, Los Angeles, CA, 90024, US

(21) Appl. No.: 09/728,755

(22) Filed: Dec. 4, 2000

Related U.S. Application Data
(60) Provisional application No. 60/190,549, filed on Mar. 20, 2000.

(51) Int. Cl. A01K 27/00

(52) U.S. Cl. 119/769

(57) ABSTRACT

A tethering system (20) for an animal (502) includes a ground station (22) which is suitable for insertion into the ground (500). The ground station has an upwardly opening cavity (23). A portable pin (32) is shaped and dimensioned to be rotatably received by the cavity of the ground station. Pin (32) has a tether connector (34) at one end, so that when the pin is inserted into the ground station, the pin and tether connector may swivel 360°. In a preferred embodiment, a plurality of ground stations are installed in the ground, and the pin is sequentially moved from one ground station to another ground station as desired to provide a new area for the animal.

### CROSS REFERENCE TO RELATED APPLICATION

This application claims the filing benefit under 35 U.S.C. §119(e) of U.S. Provisional Application No. 60/190,549, filed Mar. 20, 2000, which is included herein by reference.

### TECHNICAL FIELD

The present invention pertains generally to restraining animals, and more particularly to a tethering system which can be easily and quickly moved from location to location, and which allows the animal a full 360 degrees of rotational freedom.

### BACKGROUND ART

Devices for containing and restraining animals are well known in the art. Such devices include cages, pens, corrals, runs, fenced areas, and the like. Where it is impractical to totally contain the animal, a leash or rope is often used which limits the animal's range to a preselected area. The leash or rope is used to tie the animal to a stationary structure such as a tree, post, fence, or building. However, this method of restraint is troublesome in that the leash and rope can become entwined about various obstacles, including the stationary structure, having the undesirable result of severely limiting the motion of the animal. Also, the area where the animal is restrained, for example a lawn, can become excessively worn by the continuous movement of the animal.

Examples of animal tethering systems include U.S. Pat. No. 4,738,222 which discloses an animal tether comprising a base plate, a ground stake which extends through the base plate at about a 90° angle, the upper end of the ground stake projecting beyond the upper surface of the base plate and the lower end of the stake adapted to project into the ground for positive engagement with the ground, an upright tubular member which cooperatively slides over the upper end of the ground stake so as to freely rotate around the stake, the tubular member having a bend or curve of about 5° to 45° relative to the ground stake, a flexible rod, the lower end of which is secured into the upper end of the tubular member, the upper end of the flexible rod being fitted with a guide for receiving a tether line, and a tether line, one end of which is secured to the tubular member and the other end is threaded through the guide and secured to the animal. U.S. Pat. No. 5,305,712 shows another tether system for an animal. The tether system has an apparatus which is electrically or fluidically powered or monitored with greater than 200 milliamps of current. The tether system is also comprised of an area for the animal and a structure above the area. The tether system is comprised of an anchor for attachment to the structure. The tether system is also comprised of a mechanism for providing power to the apparatus to operate it. The providing mechanism is in electrical communication with the anchor and the apparatus. The anchor prevents entanglement of the power providing means or mechanism as the animal moves freely about the area. Preferably, the tether system also includes a mechanism for providing fluid to or from the animal. The fluid providing mechanism is fluidically connected to the anchor and the animal. Additionally, the tether system can include a mechanism for transmitting electrical signals from the animal. The transmitting mechanism is in electrical communication with the anchor and the animal. The present invention also pertains to a method for tethering an animal with an apparatus which is electrically powered. The method comprises the steps of attaching a first electrical conduction element to the apparatus of the animal so the first electrical conduction element extends from an anchor attached to a structure above and remote from the animal to the animal. Then, there is the step of providing current to the apparatus to power it. Next, there is the step of allowing the animal to freely walk around the area while connected to the first electrical conduction element.extending down from the anchor attached to the structure above the animal in the area. U.S. Pat. No. 6,029,611 illustrates an animal tethering system which is attachable to a collar or harness worn by the animal to restrain the animal in the cargo area of a vehicle. The system has a short control lead having a loop handle at one end and a fastener at the other. A longer extension leash has fasteners at both ends. When tethered, the control lead is secured by its fastener to one tie down. The extension leash has one end secured to the opposite vehicle tie down and is threaded through the loop of the lead and fastened at its opposite end to the animal's collar or harness. Preferably the attachment location is to a harness in the chest area of the animal. The control lead may be used alone or with the extension leash as a lead when walking the animal.

### DISCLOSURE OF INVENTION

The present invention is directed to an improved tethering system for an animal. It is particularly useful for restraining dogs. However, it could also be used for a variety of other animals. It permits an animal to be tethered and roam in a full 360 degree circle without tangling. One major advantage of the invention is that it permits the tethering area to be conveniently and rapidly relocated. This is made possible by having a plurality of ground stations installed in the ground, so that a portable pin and swiveling tether connector may be moved from ground station to ground station. The ground station is typically installed in the ground by hammering, and the pin is then simply dropped into a cavity in the ground station. As the animal circumferentially moves around the ground station, the pin rotates within the ground station and therefore the tether does not become entangled. A preferred name for the present invention is MIGHTY MAX DOG PORT.

In accordance with a preferred embodiment of the invention, a tethering system for an animal includes a ground station which is vertically inserted into the ground. The ground station has an upwardly opening cavity which rotatably receives a portable pin. The pin has a tether connector at its upper end. When the pin is inserted into the ground station, the pin and the tether connector may swivel 360°.

In accordance with an important aspect of the invention, a ground station has a stabilizer gusset which prevents it from rotating when it is inserted in the ground.

In accordance with an important feature of the invention, the ground station has a flange which abuts the ground when the ground station is installed. The flange prevents the ground station from becoming lost below the surface of the ground.

Other features and advantages of the present invention will become apparent from the following detailed description, taken in conjunction with the accompanying drawings, which illustrate, by way of example, the principles of the invention.

### BRIEF DESCRIPTION OF DRAWINGS

FIG. 1 is an exploded side elevation view of a tethering system for an animal in accordance with the present invention;

FIG. 2 is a view along the line 2-2 of FIG. 1;

FIG. 3 is a view along the line 3-3 of FIG. 1;

FIG. 4 is a view along the line 4-4 of FIG. 1;

FIG. 5 is a view along the line 5-5 of FIG. 1;

FIG. 6 is a reduced side elevation view showing a pin being inserted into a ground station;

FIG. 7 is a reduced side elevation view showing the pin inserted into the ground station, and the ground station inserted into the ground; and, FIG. 8 is a reduced perspective view of showing a plurality of ground stations which may receive the pin and tether connector.

### MODES FOR CARRYING OUT THE INVENTION

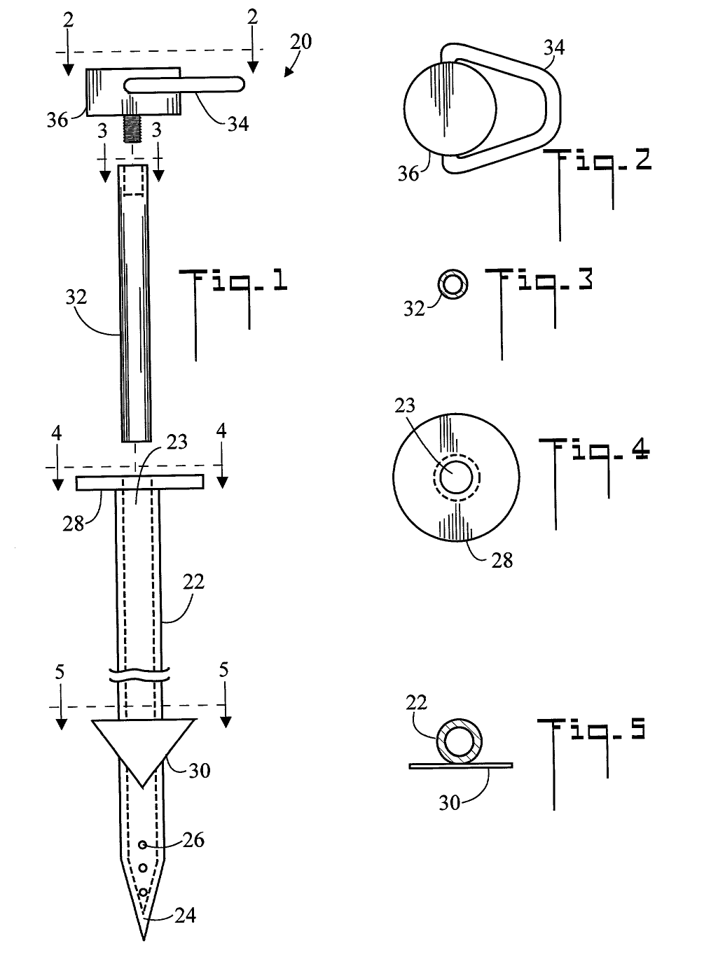

Referring initially to FIG. 1, there is illustrated an exploded side elevation view of a tethering system for an animal in accordance with the present invention, generally designated as 20. Tethering system 20 includes an elongated ground station 22 which is insertable into the ground. Ground station 22 has an elongated upwardly opening cavity 23 (also refer to FIG. 4). In a preferred embodiment, ground station 22 is a pipe like member, approximately two feet in length, having a tapered end 24 with drain holes 26. Ground station 22 also has a flange 28 which abuts the surface of the ground when ground station 22 is inserted therein, thereby preventing ground station 22 from totally entering the ground. Flange 28 has a hole opening into cavity 23. Ground station 22 also has a stabilizer gusset 30 which prevents ground station 22 from rotating in the ground.

An elongated pin 32 is shaped and dimensioned to be slidably and rotatably received by cavity 23 of ground station 22. In a preferred embodiment, pin 32 has a cylindrical body which slidably and rotatably fits into cylindrical cavity 23 of ground station 22. Pin 32 has a tether connector 34, such as the shown D-ring, at one end. The tether connector attaches to a tethering material such as a rope or cable. Tether connector 34 is pivotally connected to a swivel housing 36 which is connected to pin 32. When pin 32 is inserted into cavity 23 in ground station, pin 22 and tether connector 34 may swivel a full 360° within cavity 23 of ground station 22.

FIG. 2 is a view along the line 2-2 of FIG. 1, showing tether connector 34 and swivel housing 36.

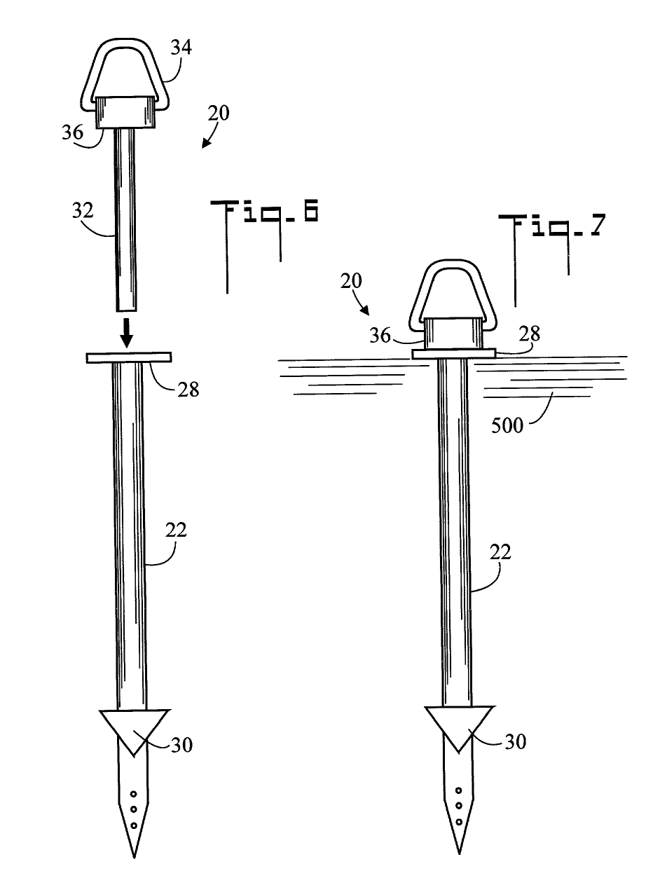

FIG. 3 is a view along the line 3-3 of FIG. 1, showing how swivel housing 36 is threadably received by pin 32.

FIG. 4 is a view along the line 4-4 of FIG. 1, showing flange 28 having a hole which opens into cavity 23 in ground station 22.

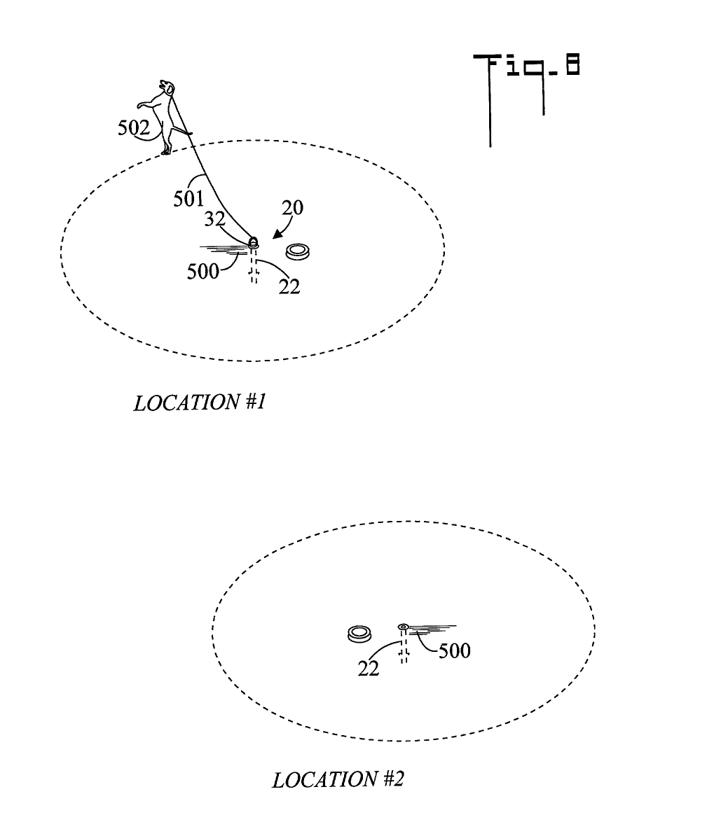

FIG. 5 is a view along the line 5-5 of FIG. 1, showing stabilizing gusset 30 connected to ground station 22.

FIG. 6 is a reduced side elevation view showing a pin 32 being inserted into a ground station 22. It is noted that tether connector 34 has been pivoted to a substantially upright position.

FIG. 7 is a reduced side elevation view showing pin 32 inserted into the ground station 22, and ground station 22 inserted into the ground 500.

FIG. 8 is a reduced perspective view showing a plurality of ground stations 22 which may receive pin 32 and tether connector 34. Ground station 22 is inserted into the ground 500 so that it is flush with the surface and assumes a substantially vertical orientation. Pin 32 is then inserted (dropped) into ground station 22, and a tethering material such as a rope or line 501 is used to couple the animal 502 to the tether connector 34 of pin 32 such as by tying. Additional ground stations 22 can be provided and inserted into the ground 500, so that the animal 502 may be rapidly moved from one location to another. In the figure, an animal 502 has been tethered in Location #1 using the present device. Location #2 is another tethering area in which an additional ground station 22 has been installed. All that is required to move the animal 502 from Location #1 to Location #2 is to lift the portable pin 32 from the ground station 22 at Location #1, and move it along with the rope or line 501 and the animal 502 to Location #2, and install the portable pin 32 in the ground station 22 at Location #2.

Only gravity holds pin 32 in place. While it is easy for a human to understand that the pin can be easily removed from the ground station 22 by lifting it straight up, a dog or other similar animal would not understand and will always try to pull against the restraint to the side. The pin 32 only needs to be so long that the animal cannot accidentally pull the pin up out of the ground station 22. For example, the pin only needs to be as long as the dog is tall. A pin having a twelve inch length and three-quarter inch diameter has been found to be useful. Such a pin weighs substantially five pounds and presents a formidable obstacle for a dog trying to get away when inserted in a snug ground station 22.

Primates are a different matter because they might learn to grasp the pin itself and lift it up out of the ground station. Other means for restraining primates would there for be necessary.

The present invention provides a method for tethering an animal 502. A ground station 22 is inserted into the ground 500 so that it assumes a substantially vertical orientation with respect to the plane of the surface of the ground. A pin 32 having a tether connector 34 at one end is inserted into the cavity 23 in the ground station 22. And, a tethering material 501 is coupled to the tether connector 34 and an animal 502.

The method can also include providing at least one additional ground station 22, inserting the at least one additional ground station 22 into the ground 500 so that it assumes a substantially vertical orientation, and, moving pin 32 and inserting it into the cavity 23 of the at least one additional ground station 22, The preferred embodiments of the invention described herein are exemplary and numerous modifications, dimensional variations, and rearrangements can be readily envisioned to achieve an equivalent result, all of which are intended to be embraced within the scope of the appended claims.

We claim:

1. A tethering system for an animal, comprising;
a ground station insertable into the ground, said ground station having an upwardly opening cavity;
a pin shaped and dimensioned to be rotatably received by said cavity of said ground station, said pin having a tether connector at one end; and,
so that when said pin is inserted into said ground station, said pin and said tether connector may swivel 360°.

2. A tethering system according to claim 1, further including:
said ground station having a stabilizer gusset for preventing said ground station from rotating when inserted in the ground.

3. A tethering system according to claim 1, further including:
said ground station having a flange for abutting the ground.

4. A tethering system according to claim 1, further including:
said ground station having a stabilizer gusset for preventing said ground station from rotating in the ground; and,
said ground station having a flange for abutting the ground.

5. A method of tethering an animal, comprising:
providing an animal and a tethering material;
providing a pin having a tether connector at one end;
providing a ground station having a cavity sized to rotatably receive said pin;
inserting said ground station into the ground so that it assumes a substantially vertical orientation;
inserting said pin into said cavity in said ground station; and,
using said tethering material to couple said animal,to said tether connector.

6. The method of claim 5, further including:
providing at least one additional ground station having a cavity sized to rotatably receive said pin;
inserting said at least one additional ground station into the ground so that it assumes a substantially vertical orientation; and,
moving said pin and inserting it into said cavity of said at least one additional ground station.
